(19) United States
(12) Patent Application Publication
(10) Pub. No.: US 2008/0251054 A1
(43) Pub. Date: Oct. 16, 2008

(54) UTILITY ENGINE

(75) Inventors: Kunihiko Otsuka, Shizuoka-ken (JP); Osamu Suzuki, Shizuoka-ken (JP); Shinya Tsuda, Shizuoka-ken (JP); Satoshi Makino, Shizuoka-ken (JP)

Correspondence Address: KNOBBE MARTENS OLSON & BEAR LLP, 2040 MAIN STREET, FOURTEENTH FLOOR, IRVINE, CA, 92614, US

(73) Assignee: YAMAHA MOTOR POWER PRODUCTS KABUSHIKI KAISHA, Shizuoka-ken (JP)

(21) Appl. No.: 11/954,837

(22) Filed: Dec. 12, 2007

(30) Foreign Application Priority Data
Dec. 14, 2006 (JP) 2006-337220

(51) Int. Cl. F02M 33/02

(52) U.S. Cl. 123/519

(57) ABSTRACT

A utility engine has a cylinder body extending obliquely upward from a crankcase and a cylinder head attached to an end of the cylinder body. The utility engine has a carburetor attached to a side of the cylinder head and an air cleaner attached to a side of the carburetor opposite the cylinder head. The canister is located below the carburetor and adjacent to the air cleaner.

### CROSS-REFERENCE TO RELATED APPLICATIONS

This application claims the benefit of Japanese Patent Application No. JP 2006-337220, filed on Dec. 14, 2006, the disclosure of which is incorporated herein by reference in its entirety.

### BACKGROUND OF THE INVENTION

1. Field of the Invention

The present invention relates to a utility engine having a canister for adsorbing evaporated gas in a fuel tank.

2. Description of the Related Art

A conventional utility engine having a canister for adsorbing evaporated gas in a fuel tank is disclosed in, for example, JP-A-Hei 7-34985. The utility engine disclosed in JP-A-Hei 7-34985 has a canister in the cap of the fuel tank or in the air cleaner.

The canister is formed in a size corresponding to the capacity of the fuel tank. Therefore, the cap or the air cleaner must comprise an accommodation space large enough to accommodate the canister.

### SUMMARY OF THE INVENTION

Because the canister is incorporated into either the cap or the air cleaner, the cap of the fuel tank or the air cleaner must be enlarged to accommodate the canister. In addition, different caps or air cleaners must be produced for different types of engines (i.e., to provide for fuel tanks having different capacities) so that a canister having a size corresponding to the capacity of the fuel tank can be accommodated. Generating these differing caps or air cleaners increases production cost.

Such problems can be overcome to some extent by using canisters sold separately. However, when this configuration is employed, the engine increases in size depending on where the canister is installed.

Certain features, aspects and advantages of an embodiment of the present invention have been made to solve the above problems, and it is, therefore, an object of the present invention to provide, at a low production cost, a utility engine that can be provided with a canister having a size corresponding to the capacity of the fuel tank.

One aspect of the present invention involves a utility engine comprising a canister for adsorbing evaporative gas in a fuel tank where the engine comprises a cylinder body extending obliquely upward from a crankcase. A cylinder head is attached to an end of the cylinder body. A carburetor is attached to the cylinder head. An air cleaner is attached to the carburetor such that the carburetor is interposed between the air cleaner and the cylinder head. The canister is located below the carburetor at a location generally adjacent to the air cleaner.

### BRIEF DESCRIPTION OF THE DRAWINGS

These and other features, aspects and advantages of the present invention will now be described with reference to the drawings of a preferred embodiment, which embodiment is intended to illustrate and not to limit the invention.

FIG. 1 is a left side view of a utility engine that is arranged and configured in accordance with an embodiment of the present invention.

FIG. 2 is a front view of the utility engine of FIG. 1.

FIG. 3 is a rear view of the utility engine of FIG. 1.

FIG. 4 is an enlarged cross-sectional view of a filling opening of a fuel tank that can be used in the embodiment of FIG. 1.

### DETAILED DESCRIPTION OF THE PREFERRED EMBODIMENT

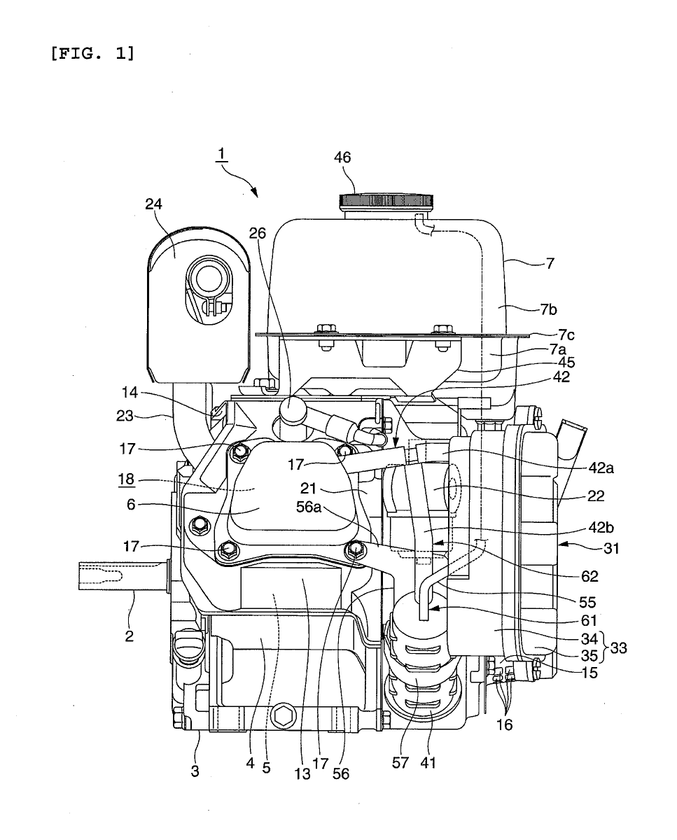

Description is hereinafter made of an embodiment of a utility engine that is arranged and configured in accordance with certain features, aspects and advantages of an embodiment of the present invention. The following description will be made in detail with reference to FIG. 1 to FIG. 4.

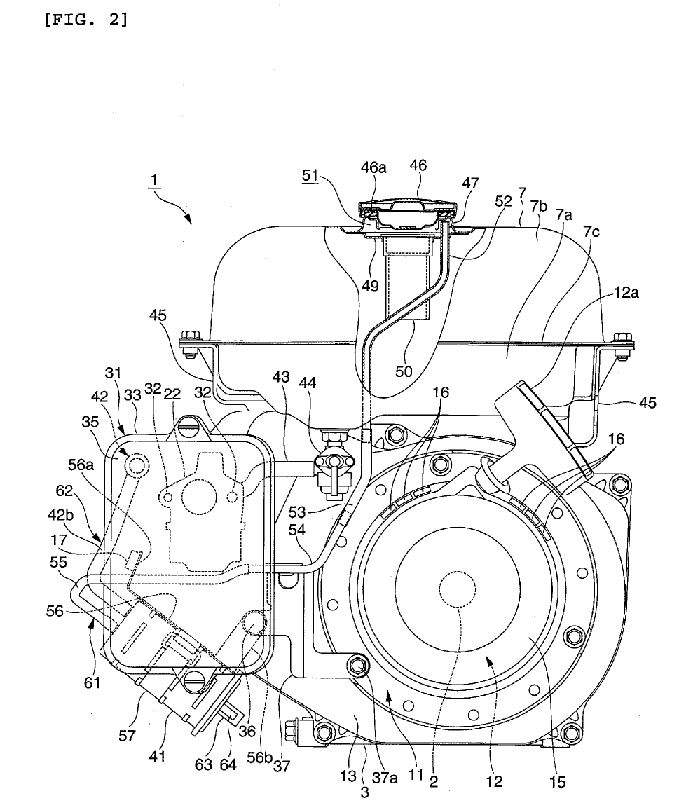

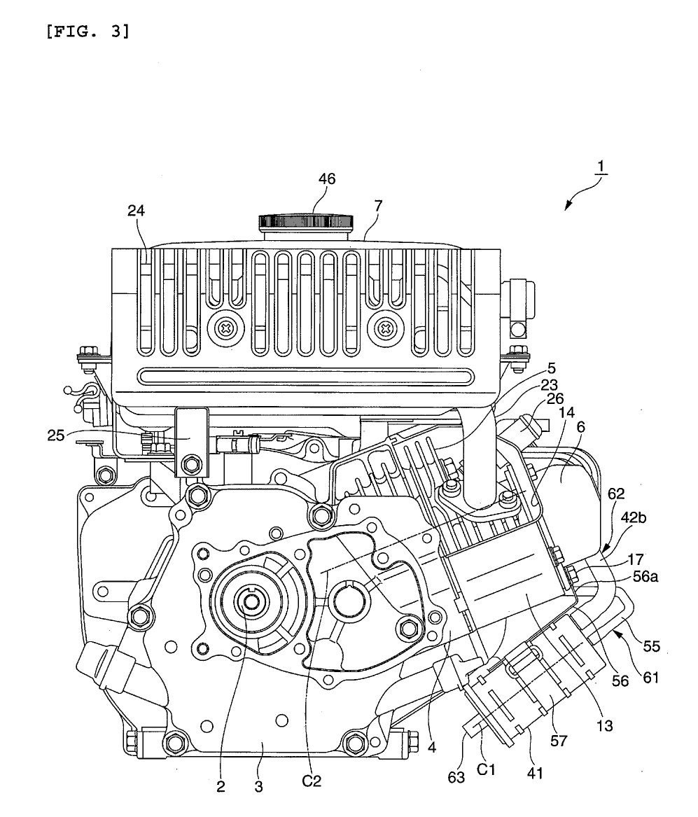

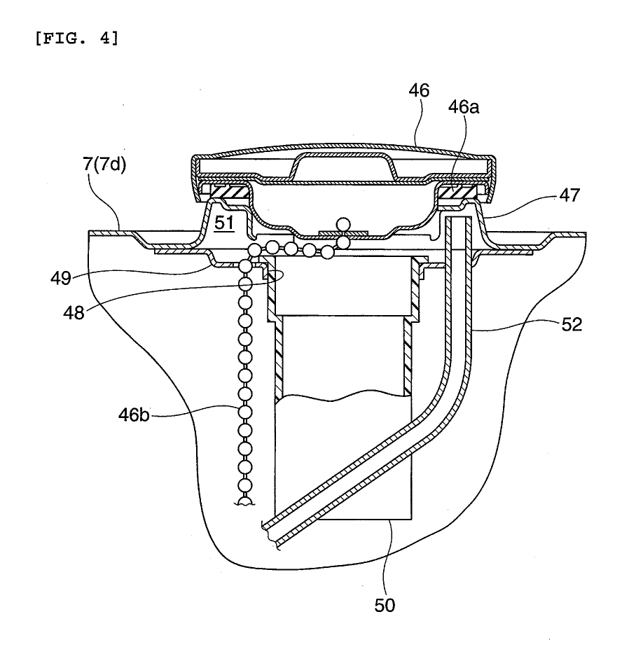

FIG. 1 is a left side view of the utility engine that is arranged and configured in accordance with an embodiment of the present invention, FIG. 2 is a front view of the utility engine, and FIG. 3 is a rear view of the utility engine. FIG. 4 is an enlarged cross-sectional view of a filling opening of a fuel tank.

In the drawings, designated as 1 is a utility engine of this embodiment. The utility engine 1 is a forced air-cooled, four-cycle single-cylinder engine. The engine 1 has a crankcase 3 that can be split such that the separating plane intersects the axial direction of a crankshaft 2, which extends in the lateral direction as viewed in FIG. 1. The engine 1 also comprises a cylinder body 4 (see FIG. 3) that extends obliquely upward from the crankcase 3. A cylinder head 5 attaches to an end of the cylinder body 4. A head cover 6 attaches to an end of the cylinder head 5. A fuel tank 7 preferably is located above the crankcase 3 as shown in FIG. 1.

The crankshaft 2 is rotatably supported by the crankcase 3 with an axis of the crankshaft 2 extending horizontally as shown in FIG. 1. A connecting rod (not shown) connects the crankshaft 2 and a piston (not shown) that is received in the cylinder body 4. One end (i.e., left end as viewed in FIG. 1) of the crankshaft 2 protrudes from the crankcase 3 as shown in FIG. 1 so that a driven device, such as an operating machine (not shown), can be connected thereto. Although not shown, the other end of the crankshaft 2 protrudes from the crankcase 3 and a fan (not shown) of a forced air-cooling type cooling device 11 (see FIG. 2) and a recoil starter 12 are attached to the protruded end.

The cooling device 11 comprises the fan and an engine cover 13, which serves as a shroud and which forms a cooling air passage. The engine cover 13 generally surrounds the fan, the cylinder body 4 and the cylinder head 5. The engine cover 13 preferably is configured to direct cooling air from the fan to the cylinder body 4 and the cylinder head 5. The engine cover 13 preferably comprises a cooling air discharge opening 14 (see FIG. 3) formed through a side thereof opposite the side where the fan is located. Air that has cooled the cylinder body 4 and the cylinder head 5 exits through the cooling air discharge opening 14.

The part of the engine cover 13 facing the fan comprises a recoil starter case 15, as shown in FIG. 2. The recoil starter case 15 preferably has the shape of a bottomed circular cylinder that opens toward the fan. The recoil starter case 15 preferably supports a reel, a rope and the like of a recoil starter 12. When an operation lever 12a (see FIG. 2) of the recoil starter 12 is pulled, the crankshaft 2 rotates.

Multiple cooling air intake openings 16 open through a periphery of the recoil starter case 15. While only a few of the openings 16 are shown, the cooling air intake openings 16 preferably are formed along the entire periphery of the recoil starter case 15.

Although not shown, the cylinder head 5 comprises an intake valve, an exhaust valve, and an OHV type valve operating system for driving the intake and exhaust valves. The illustrated head cover 6, which covers the valve operating system, is secured to an end (e.g., an upper end) of the cylinder head 5 by four fixing bolts 17. A blow-by gas chamber 18 communicates with a crank chamber (not shown) of the engine. The blow-by gas chamber 18 preferable is defined in the head cover 6.

A carburetor 22, which is described later, can be connected via an intake pipe 21 to one side of the cylinder head 5. Preferably, the carburetor is connected to the same side of the cylinder head 5 on which the cooling device 11 is located in the axial direction of the crankshaft 2 (see FIG. 1). An exhaust pipe 23 can be connected to the opposite side of the cylinder head 5 relative to the intake pipe 21. The exhaust pipe 23 extends upward from the cylinder head 5 and connects a muffler 24, which is located above the crankcase 3, to the cylinder head 5. The muffler 24 preferably is generally aligned with the fuel tank 7 in elevation (i.e., as shown in FIG. 1, the bottoms of the muffler 24 and the fuel tank 7 preferably are generally aligned). A supporting bracket 25 (see FIG. 3) supports the muffler 24 on an upper end of the crankcase 3.

A spark plug (not shown) is attached to an upper part of the cylinder head 5. The spark plug is connected to an ignition device (not shown) by an ignition cable that terminates in a plug cap 26 (see FIG. 1 and FIG. 3).

An air cleaner 31 is connected to an end of the carburetor 22 opposite the cylinder head 5 as shown in FIG. 1. The carburetor 22 preferably is secured to the cylinder head 5 together with the air cleaner 31 by fastening bolts 32 (see FIG. 2).

The air cleaner 31 has an air cleaner case 33 in the shape of a relatively flat box. The shape preferably is vertically elongated as shown in FIG. 1 and FIG. 2. The air cleaner case 33 contains an air cleaner element (not shown). The air cleaner case 33 has a case body 34 facing the cylinder head 5 and a lid 35 that is removably attached to the case body 34, as shown in FIG. 1.

The case body 34 preferably is in the shape of a bottomed rectangular cylinder opening outward on a side of the engine. The lid 35 preferably has a shape that closes the opening of case body 34. The case body 34 can supported on the engine 1 by the carburetor 22, which is attached to an upper part of its inside bottom (i.e., the vertical wall facing the cylinder head 5), and by a fixing bolt 36 (see FIG. 2) that extends through a lower part of the inside bottom from inside of the case to outside. An end of the fixing bolt 36 preferably is threaded into a nut (not shown) that is secured, for example by welding, to the engine cover 13. The nut preferably is fixed to an inner surface of the engine cover 13.

The fixing bolt 36 extends through a through-hole (not shown) formed through the engine cover 13 and the bolt 36 is threadedly engaged with the nut. The fixing bolt 36 extends through a front end of a pipe holding bracket 37, which is described later, and an end 56b of a canister supporting bracket 56, which is described later. That is, a lower part of the case body 34, a front end of the pipe holding bracket 37, and the end 56b of the canister supporting bracket 56 are secured together to the engine cover 13 by the fixing bolt 36. A rear end of the pipe holding bracket 37 is secured to the recoil starter case 15 by a fixing bolt 37a.

A gas suction pipe 42 through which blow-by gas and gas in a canister 41 located in the vicinity of the air cleaner 31 are drawn can be connected to an upper corner of the inside bottom of the case body 34 as shown in FIG. 2. The gas suction pipe 42 preferably has a horizontally extended portion 42a that extends generally horizontally between the air cleaner 31 and the head cover 6, and a vertically extended portion 42b that extends downward from an intermediate portion of the horizontally extended portion 42a, as shown in FIG. 1. The horizontally extended portion 42a fluidly connects the blow-by gas chamber 18 in the head cover 6 and the inside of the air cleaner case 33 while the vertically extended portion 42b fluidly connects the inside of the canister 41 and the inside of the horizontally extended portion 42a.

A throttle valve (not shown) provided in the carburetor 22 is operatively connected to a governor device (not shown) provided in the crankcase 3. Preferably, the opening of the throttle valve is controlled by the governor device to maintain the rotational speed of the engine at a prescribed value.

A fuel passage in the carburetor 22 is connected to the fuel tank 7 by a fuel hose 43 and a fuel cock 44, as shown in FIG. 2.

The fuel cock 44 is attached to the bottom of the fuel tank 7 and the fuel cock 44 allows the fuel in the fuel tank 7 to flow selectively into the fuel hose 43.

The fuel tank 7 comprises an upper half 7b and a lower half 7a that are joined by seam welding, for instance, as shown in FIG. 1 and FIG. 2. A supporting bracket 45, which is attached to a seam welding flange 7c of the fuel tank 7, mounts the fuel tank 7 relative to the crankcase 3.

The fuel tank 7 has a mounting seat 47. A cap 46 attaches to the mounting seat 47 at an upper end of the fuel tank 7 as shown in FIG. 2 and FIG. 4. The illustrated mounting seat 47 comprises an annular shape as viewed in a plan view. A partially protruding upper wall 7d of the fuel tank 7 that protrudes upwardly preferably defines the illustrated mounting seat 47. The mounting seat 47 is brought into tight contact with a seal member 46a of the cap 46 to form a liquid-tight seal between the mounting seat 47 and the cap 46 when the cap 46 is threaded onto the mounting seat 47.

A partition 49 having a filling opening 48 is provided below the mounting seat 47. A strainer 50 in the shape of a circular cylinder is inserted into the filling opening 48. Although not shown, a net for straining foreign objects can be provided in the periphery of the strainer 50. A chain 46b (see FIG. 4) for preventing loss of the cap 46 can be attached to a lower end of the cap 46.

The partition 49 can be located a short distance below the mounting seat 47 to form an evaporative gas chamber 51 between the partition 49 and the mounting seat 47. An evaporative gas pipe 52 that directs evaporative gas in the fuel tank 7 to the canister 41, which is described later, extends through the partition 49 and is fixed to the partition 49 by welding, for instance. The upper end of the pipe 52 opens into the evaporative gas chamber 51.

The evaporative gas pipe 52 extends downward through the fuel tank 7 and protrudes through the bottom wall of the fuel tank 7. The lower end of the pipe 52 is connected to the canister 41 via a first rubber pipe 53, a connecting pipe 54 and a second rubber pipe 55 as shown in FIG. 2. The connecting pipe 54 is held on an upper end of the pipe holding bracket 37, which is attached to a lower part of the air cleaner 31 and the recoil starter case 15.

The canister 41 preferably is in the shape of a circular column and contains an adsorbent (not shown) therein for adsorbing or releasing evaporative gas, such as fuel vapor, as needed or desired. Any suitable commercially available canister can be used as the canister 41. While the illustrated canister 41 has the shape of a circular column, the present invention is not limited thereto. The canister 41 may have a different shape, such as the shape of a rectangular column, for instance but without limitation.

The canister 41 preferably is located below the carburetor 22 and adjacent to the air cleaner 31 (i.e., adjacent in the axial direction of the crankshaft 2) as shown in FIG. 1 and FIG. 2. The canister 41 can be located on the supporting bracket 56, which is fixed to the head cover 6 and the air cleaner 31. The canister 41 preferably is fastened to the bracket 56 by a band 57. The supporting bracket 56 can be formed by cutting and bending a metal plate-like material into a prescribed shape that is elongated in the longitudinal direction of the canister 41.

An upper end 56a of the supporting bracket 56 can be secured to the cylinder head 5 together with the head cover 6 by one of four fixing bolts 17, for example, which are used to secure the head cover 6 to the cylinder head 5, as shown in FIG. 1. The other end 56b of the supporting bracket 56 can be secured to the engine cover 13 together with the case body 34 and a front end of the pipe holding bracket 37 with the fixing bolt 36 that secures the case body 34 of the air cleaner 31 to the engine cover 13, as shown in FIG. 2. In the illustrated embodiment, the other end 56b of the supporting bracket 56 can be located along the vertical wall of the case body 34 while the front end of the pipe holding bracket 37 is sandwiched between the other end 56b and the engine cover 13.

The canister 41 advantageously is inclined generally along the cylinder body 4 when viewed in the axial direction of the crankshaft 2 (see FIG. 3). In the illustrated embodiment, the inclination angle of the axis C1 of the canister 41 with respect to a horizontal line is slightly larger than the angle of the axis C2 of the cylinder with respect to the horizontal line. Since the canister 41 is inclined as described above, the lower end of the canister 41 is directed to the inside of the engine 1 as shown in FIG. 2 and FIG. 3. Also, since the canister 41 is inclined as described above, at least a portion (e.g., an upper half) of the canister 41 overlaps the air cleaner 31 when viewed in the axial direction of the crankshaft 2 (see FIG. 2).

The second rubber pipe 55 and the vertically extended portion 42b of the gas suction pipe 42 are connected to an upper end of the canister 41. The second rubber pipe 55, the connecting pipe 54, the first rubber pipe 53 and the evaporative gas pipe 52 define an evaporative gas inflow pipe 61 having a second end opening in the fuel tank 7. The vertically extended portion 42b and a part of the horizontally extended portion 42a of the gas suction pipe 42 define an evaporative gas suction pipe 62 having a second end opening in the air cleaner 31.

An air vent pipe 63 and a water vent pipe 64 protrude from the lower end of the canister 41 in a direction generally parallel to the axial direction of the canister 41. The internal spaces in the pipes 63 and 64 form an air vent port and a water vent port, respectively, communicating the inside and outside of the canister 41. The air vent port and the water vent port are directed and open toward the inside of the engine 1 since the canister 41 is inclined as described above. The air vent port and the water vent port open near the cooling air intake openings 16 formed through a lower part of the recoil starter case 15.

In the above-described utility engine 1, evaporative gas generated by vaporization of fuel in the fuel tank 7 when the engine 1 is not operating flows into the canister 41 through the evaporative gas inflow pipe 61 (the evaporative gas pipe 52, the first rubber pipe 53, the connecting pipe 54, and the second rubber pipe 55) and is adsorbed by the adsorbent in the canister 41. At this time, air generated by removal of fuel component from the evaporative gas by the adsorption is discharged from the lower end of the canister 41 to the outside of the canister 41 through the air vent pipe 63 (i.e., the air vent port). Water having entered the canister 41 for some reason is discharged to the outside of the canister 41 through the water vent pipe 64.

When the utility engine 1 is operating, a negative pressure is transmitted from the air cleaner 31 to the inside of the head cover 6 and the canister 41 through the gas suction pipe 42. Therefore, blow-by gas in the head cover 6 is sucked into the air cleaner 31 through the gas suction pipe 42. When the negative pressure is transmitted to the inside of the canister 41, outside air is sucked into the canister 41 through the air vent pipe 63. Then, the fuel having been adsorbed in the adsorbent is released from the adsorbent and returned to gas air flow, and the air flow containing the fuel vapor is sucked into the vertically extended portion 42b of the gas suction pipe 42. As a result, evaporative gas composed of blow-by gas and fuel vapor is sucked into the air cleaner 31 through the gas suction pipe 42.

The canister 41 is located below the carburetor 22 attached to a side of the cylinder head 5, and adjacent to the air cleaner 31 attached to a side of the carburetor 22 opposite the cylinder head 5. Therefore, in the illustrated utility engine 1, the canister 41 is disposed in a dead space formed below the carburetor 22 and along the air cleaner 31. Thus, reduced production cost can be achieved because the commercially available canister 41 is used instead of a canister that is incorporated into an exclusive part, such as the cap 46 of the fuel tank 7 or the air cleaner 31. In addition, the canister 41 can be easily installed using otherwise empty space in the engine construction.

Also, because the canister 41 is located in the vicinity of the cylinder head 5, the canister 41 is heated by heat from the cylinder head 5 when the engine is operating. Therefore, the fuel adsorbed in the canister 41 can be evaporated and sucked into the air cleaner 31 efficiently when the engine is operating.

In the illustrated utility engine 1, the supporting bracket 56 that supports the canister 41 on the engine is secured to the cylinder head 5 together with the head cover 6 by one of the fixing bolts 17 otherwise used to secure the head cover 6. Therefore, the supporting bracket 56 can be secured to the engine 1 without a separate mounting seat and fixing bolt. As a result, the production cost is reduced as compared to the case where a mounting seat exclusively for the canister 41 is provided on the engine 1 and a canister supporting bracket is secured to the mounting seat by an exclusive fixing bolt.

In the illustrated utility engine 1, the canister 41 is inclined along the cylinder body 4 as viewed in the axial direction of the crankshaft 2 while the second rubber pipe 55 and the vertically extended portion 42b of the gas suction pipe 42 are connected to the upper end of the canister 41 and an air vent port is formed through the lower end of the canister 41. Therefore, because the air vent port opens below the canister 41 and is directed to the inside of the engine 1, dust or water drops in the vicinity of the engine 1 are less likely to be sucked into the air vent port of the canister due to the orientation and placement of the air vent port.

The illustrated utility engine 1 also has some of the cooling air intake openings 16 in the engine cover 13 in the vicinity of the air vent port of the canister 41. Therefore, dust flying around the installation surface on which the engine 1 is placed and water splashed on the installation surface are more likely to be sucked into the cooling air intake openings 16 of the engine cover 13. As a result, the likelihood of entrance of dust or water into the canister 41 from outside through the air vent port can be greatly reduced.

Although the present invention has been described in terms of a certain embodiment, other embodiments apparent to those of ordinary skill in the art also are within the scope of this invention. Thus, various changes and modifications may be made without departing from the spirit and scope of the invention. For instance, various components may be repositioned as desired. Moreover, not all of the features, aspects and advantages are necessarily required to practice the present invention. Accordingly, the scope of the present invention is intended to be defined only by the claims that follow.

What is claimed is:

1. A utility engine comprising a canister for adsorbing evaporative gas in a fuel tank, the engine comprising:
a cylinder body extending obliquely upward from a crankcase;
a cylinder head attached to an end of the cylinder body;
a carburetor attached to the cylinder head;
an air cleaner attached to the carburetor such that the carburetor is interposed between the air cleaner and the cylinder head, and
the canister being located below the carburetor and adjacent to the air cleaner.

2. The utility engine according to claim 1, wherein the canister comprises a columnar shape having a axis, the axis being inclined generally along the cylinder body as viewed in an axial direction of a crankshaft, both an evaporative gas inflow pipe comprising a second end opening in a fuel tank and an evaporative gas suction pipe having a second end opening in the air cleaner connect to an upper end of the canister, and an air vent port is formed through a lower end of the canister.

3. The utility engine according to claim 2 further comprising a forced-air cooling cylinder cover comprising a cooling air intake opening, and the air vent port opening proximate the cooling air intake opening.

4. The utility engine according to claim 1, wherein the canister is supported relative to the engine by a bracket, and wherein the bracket is secured to the cylinder head together with a head cover by a threaded fastener.

5. The utility engine according to claim 4, wherein the canister comprises a columnar shape having a axis, the axis being inclined generally along the cylinder body as viewed in an axial direction of a crankshaft, both an evaporative gas inflow pipe comprising a second end opening in a fuel tank and an evaporative gas suction pipe having a second end opening in the air cleaner connect to an upper end of the canister, and an air vent port is formed through a lower end of the canister.

6. The utility engine according to claim 5 further comprising a forced-air cooling cylinder cover comprising a cooling air intake opening, and the air vent port opening proximate the cooling air intake opening.
